(19) United States
(12) Patent Application Publication
(10) Pub. No.: US 2002/0018333 A1
(43) Pub. Date: Feb. 14, 2002

(54) Apparatus and method for generating gravitational force/gravitational field

(76) Inventor: Rakesh Goel, Roorkee (IN)

Correspondence Address: JACOBSON HOLMAN PLLC, 400 SEVENTH STREET N.W., SUITE 600, WASHINGTON, DC, 20004, US

(21) Appl. No.: 09/766,588

(22) Filed: Jan. 23, 2001

(30) Foreign Application Priority Data
Aug. 3, 2000 (IN) 440/CAL/2000

(51) Int. Cl. H01H 47/00

(52) U.S. Cl. 361/143

(57) ABSTRACT

There is disclosed an apparatus for generating gravitational force/gravitational field, which, for example, may be used in space and avionics applications, said apparatus comprising a capacito-inductor, constituted by at least two coils, made of two metal layers with two dielectric layers provided therebetween, said coils being wound in predetermined turns on a cylindrical core of an insulating material; a magnet placed at the center of said capacito-inductor for creating and passing radial magnetic field through the capacito-inductor; power supplies for applying equal and opposite current pulses at the end terminals of said two metal layers of the capacito-inductor, and also for applying predetermined voltage between the same end terminals of said metal layers; and a drive source for rotating the capacito-inductor, journalled between two covers.

Also disclosed a method of generating gravitational force/field by using said capacito-inductor.

### BACKGROUND OF THE INVENTION

1. Field of the Invention

The present invention relates to an apparatus and method for generating gravitational force/gravitational field. This may be used in the field of space travel, satellite positioning and orientation and in avionics where levitation is required to the low gravitational field of outer space.

2. Description of the Related Art

The earth's gravitational field was discovered by Sir Isaac Newton in 1686, which was postulated as Newton's Law of Gravitation and expressed in the form of a mathematical equation.

In recent years numerous researchers have worked in the field of “antigravity” and the generation of an axial gravitational force/field by artificial methods in order to generate levitational effects at these sites. In general, levitation involves the use of a fundamental (non contact) force to balance gravity. Levitation is achieved in low gravitational forces of space, but can also occur in the presence of extremely intense fields such as electromagnetic, optical and acoustic levitation which have all been demonstrated.

Bettels et al (DE198,32001 A1 1998) describe the flow of electrons (current) in a rapidly rotating spiral form superconductor and a 2.5% reduction of the gravitational field above the superconductor.

Powerful superconducting magnets are commonly in use in England, Japan and Germany to guide and propel vehicles at high speed along a guide rail. Magnetic levitation has been achieved in these vehicles by the controlled use of magnetic forces to balance gravitational forces and hold the vehicle clear of the guide rail (for contactless, frictionless support). Further, electromagnetic induction driven coils disposed on opposing sides of the guide rail, alternate in polarity along the guide rail such that the current flows in the power coils and creates a magnetic field to interact with the vehicle superconducting magnets and provide thrust to the vehicle.

Acoustic levitation has been achieved by the use of intense acoustic waves to suspend a body which is immersed in a fluid medium without obvious mechanical support. Intense acoustic waves are nonlinear in their basic character and therefore may exert a net acoustic radiation pressure on an object sufficient to balance the gravitational force and thus levitate the body. The applications of acoustic levitation in air or other gas include an acoustic positioning module which is designed to be carried in the space shuttle and used in fundamental studies of oscillation and fission of spinning drops. An acoustic levitation furnace, also to be carried by the space shuttle, has been designed to study the possibility of containerless solidification of molten materials. This could result in materials of commercial interest, and lead to the bulk processing of materials in space.

The levitation of particles by light beams has been demonstrated in the field of quarks.

Artificial satellites, termed as geostationary satellites, which are in use for communication purposes for worldwide television, international telephonic traffic, facsimile, electronic mail services, etc. are increasingly of importance because no other wideband transmission system exists. The launch of these satellites in space and their position and orientation is achieved by disposable rockets. They are essentially in free fall because gravitational force is balanced by centrifugal force and normally have to be positioned at a height of 36,000 km above earth to cover the period of rotation exactly in 24 hours. If the gravitational force/field on them is reduced then they can be positioned at a distance of much less than 36,000 km to recieve better signal strength.

The newly concieved theory for gravitational force generation which has been implemented by way of laboratory experimentation postulates that a dipole charge in a dielectric, moving in a circular path in the presence of a radial magnetic field generates an axial gravitational force when it is subjected to the impulse of a current dipole.

The equal and opposite currents in two closely wound coils of high mutual coupling can generate a very high rate of change of magnetic flux between these coils and this changing flux causes the charge dipoles to vibrate which generates a very high frequency broad band radiation including the gravity band.

According to the said theory as concieved by the applicant, gravity is generated by the motion of an electron in its orbit, which is equivalent to the sinusoidal vibration of the charge dipole in three axes. Therefore, the vibration and the velocity of a charge dipole, generates gravity.

### SUMMARY OF THE INVENTION

The first object of the invention is to provide an apparatus for generating gravitational force/field at ambient temperature or even at industrial temperature ranges without using any superconductor, acoustic or optical means.

Another object of the invention is to provide a method for generating gravitational force/field at ambient temperature or even at industrial temperature range without using any superconductor, acoustic or optical means.

The major components of the apparatus of the present invention comprise:

(a) a capacito inductor, which is a four terminal device giving the combined effect of capacitance and inductance;

(b) a permanent magnet synchronous motor;

(c) current pulse generator;

(d) magnetic circuit;

wherein the charge dipoles in the dielectric when oriented and vibrated in a radial magnetic field generate gravity.

Accordingly, the present invention provides an apparatus for generating gravitational force/gravitational field, said apparatus comprising a capacito-inductor, constituted by at least two coils, made of two metal layers with two dielectric layers provided therebetween, said coils being wound in predetermined turns on a cylindrical core of an insulating material; a magnet placed at the centre of said capacito-inductor for creating and passing radial magnetic field through the capacito-inductor; power supplies for applying equal and opposite current pulses at the end terminals of said two metal layers of the capacito-inductor, and also for applying predetermined voltage between the same end terminals of said metal layers; and a drive source for rotating the capacito-inductor, journalled between two covers; the arrangement being such that on high speed rotation of the capacito-inductor in the presence of the radial magnetic field, and on application of voltage at the same end terminals of the metal layers, charge dipole is caused to be oriented inside the dielectric layers in a radial direction with negative and positive charge directed towards the axis of rotation of the capacito-inductor in its alternate layers of dielectric, and with all the charge dipole being tilted towards the negative charge, either down or up, parallel to the axis of rotation, depending on the direction of rotation; and on application of equal and opposite current pulses between the end terminals of each of said metal layers, vibration is caused to be generated in the charge dipole, which, due to its rotation, generates gravitational force/field.

The invention further produces a method for generating gravitational force/gravitational field which comprises rotating at high speed a capacito-inductor constituted by at least two coils made of two metal layers with two dielectric layers provided therebetween, said coils being wound in predetermined turns on a cylindrical core of an insulating material with a magnet placed at the centre of said capacito-inductor, for creating and passing a radial magnetic field through the capacito-inductor, and simultaneously applying equal and opposite current pulses at the end terminals of said two metal layers of the capacito-inductor, and applying a predetermined voltage between the same end terminals of said metal layers, whereby the charge dipole is caused to be oriented inside the dielectric layers in a radial direction with negative and positive charges directed towards the axis of rotation of the capicito-inductor in its alternate layers of dielectric, with all the charge dipole being tilted towards the negative charge either down or up, parallel to the axis of rotation, depending on the axis of rotation, and vibration is caused to be generated in the charge dipole on the application of equal and opposite current pulses between the end terminals of each of said metal layers, resulting in generation of gravitational force/field.

### BRIEF DESCRIPTION OF THE DRAWINGS

FIG. 1 shows an illustrative embodiment to explain the theory, based on which the apparatus according to the present invention has been designed and developed.

FIG. 2 shows, in symbolic representation, one embodiment of a capacito-inductor as used in the apparatus according to the present invention.

FIG. 3(a) shows, in sectional view, one embodiment of the capacito-inductor, as used in the apparatus according to the present invention.

FIG. 3(b) shows diagramatically the different layers of the capacito-inductor, as illustrated in FIG. 3(a).

FIG. 4 diagramatically shows, in section, one embodiment of the apparatus according to the present invention and FIG. 5 shows, in block diagram, the interconnection amongst the various components of the embodiment of the present apparatus according to the present invention, as shown in FIG. 4.

FIGS. 6(a) and 6(b) show in sectional and plan views respectively one arrangement for generating magnetic field in the apparatus of the present invention.

FIGS. 7(a) and 7(b) show in sectional and plan views respectively another arrangement for generating magnetic field in the apparatus of the present invention.

FIGS. 8(a) and 8(b) show in sectional and plan views respectively a further arrangement for generating magnetic field in the apparatus of the present invention.

FIGS. 9(a) and 9(b) show in sectional and plan views respectively one more arrangement for generating magnetic field in the apparatus of the present invention.

FIG. 10 diagrammatically shows an embodiment of a capacito-inductor with more than four terminals, which may be used in the apparatus of the present invention.

### DETAILED DESCRIPTION OF THE INVENTION

In the capacito-inductor of the proposed apparatus, the metal layers are aluminium foils. Other metals may also be used. The dielectric may be polyester, but other dielectrics can be used. The cylindrical core is made of an insulating material like plastic. The thickness of the metal and dielectric layers is preferably in the range of 0.5 microns to 50 microns.

The inductance between the opposite terminals of the coils, as used in the apparatus of the instant invention, depends upon many factors like the number of turns, mean radius, width of coil and thickness of coil. It also depends upon metal thickness. It is proportional to the square of the number of turns, and it decreases as width or thickness is increased.

Inductance in a capacito-inductor is very important because magnetic energy is stored in the inductor and is given by:

E_{L}=(1/2)LI²

Where,

E_{L}: The energy stored in the Inductor in Watt-sec

L: Inductance of the Inductor in Henry

I: Current in Ampere

This energy is in the form of a magnetic field. The rate of change of magnetic field creates vibrations of the charge dipole in the apparatus according to this invention. Therefore, inductance is very important.

It is to be understood that the construction of capacito-inductor is very close to that of capacitors. The capacito-inductor contains two metal layers and two dielectric layers. Therefore, all theories in manufacturing a capacitor are also applied here. The major difference between a capacitor and the proposed capacito-inductor is that capacitor is a two terminal device, while the capacito-inductor is a four terminal device. It is to be understood further that in good capacitors the inductance of metal layer is kept minimum to have better performance, while in the case of the proposed capacito-inductor the inductance is very important, as explained hereinbefore. In capacitors one connection is taken from the middle of the length of the metal layer to minimize the effect of inductance, while in case of the capacito-inductor there are two connections at both ends of each metal layer. The capacitance is proportional to the area of the metal surface and the dielectric constant, while it is inversely proportional to the thickness of the dielectric or the distance between the metal layers.

The two coils of the capacito-inductor are mutually coupled with the same end terminals in the same direction. The said mutual coupling can be explained by a transformer action. As it is known, all transformers work on mutual coupling, which is more if the two coils of the transformer are closely wound. As a preferred embodiment, more than four terminals are provided in the capacito-inductor by employing a corresponding number of coils and capacitors, said coils being connected either in series or parallel.

In the apparatus of this invention the magnet is placed at the centre of the capacito-inductor, ensuring that a radial magnetic flux passes through the capacito-inductor.

An iron cylinder may be used to improve the radial magnetic flux, as will be explained hereinafter with the help of the illustrative drawings. So, there can be different ways to make the magnetic circuit but the radial magnetic field should pass through the capacito-inductor. A magnetic field with radial and tangential components gives better results.

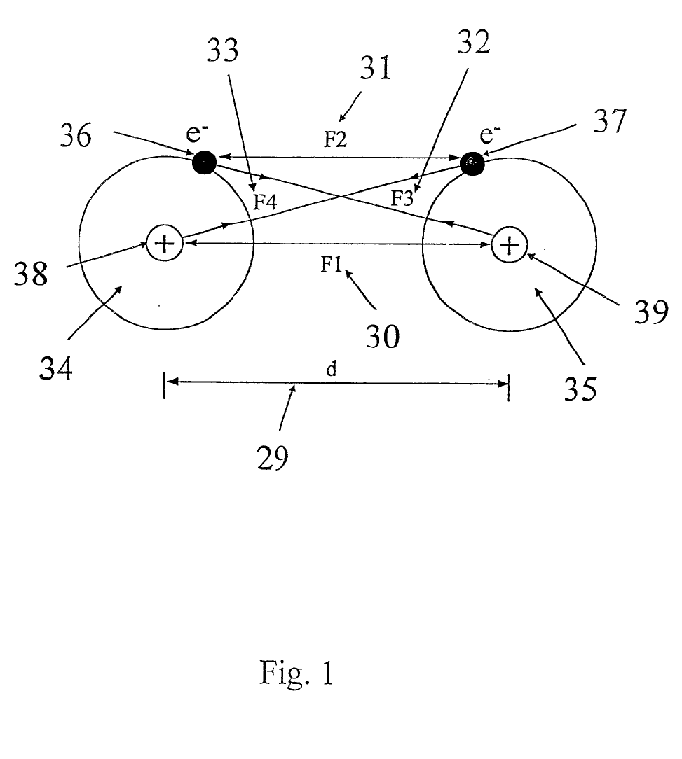

With reference to FIG. 1, if it is considered that two hydrogen atoms (34) and (35) are placed at a distance d (29), the force vector between two protons (38) and (39) is F1 (30), which is a force of repulsion. The force vector between two electrons (36) and (37) is F2 (31). The force vector between the first electron (36) and the second proton (39) is F3 (32). The force vector between the first proton (38) and the second electron (37) is F4 (33), as shown in FIG. 1. As the electrons (36) and (37) are moving around the nucleus, the force F2 (31), F3 (32) and F4 (33) will change continuously.

The resultant force Fe can be deduced to be:

Fe=F1(30)+F2(31)+F3 (32)+F4(33)

This resultant force Fe is nothing but the electrostatic force vector of gravitation force. Similarly, there is a resultant force Fm which can be calculated and this is the magnetic force vector of gravitation force. The gravitational force is the resultant vector of these two forces.

Hence, gravitation force, Fg=Fe+Fm

The probability of finding an electron in spherical co-ordinates is not uniform, and it changes significantly with distance, which effects the resultant force Fe. The probability of finding the electron is dependent on the force applied on it, and the force is dependent on its position. The average value of resultant force Fe is not ZERO, and it is positive in all elements of matter. It was solved with certain assumptions for the distance “d” (29) between the atoms, ranging from 10E-6 m to 10E+7 m by a special custom built software of mathematical accuracy greater than 200 digits. It has been observed that the answer is never zero.

A simple analogy is that if there is one voltage source of 1000 V DC and another source of 1000V DC having a ripple of 1 volt then the average voltage of both the sources will be 1000 V. However, the RMS voltage in the second source will be more than that of the first source, and difference between these two voltage sources will not be zero. The RMS value is always, greater or equal to the average value. Therefore, the resultant force Fg (gravitation force) will not be zero even at higher distances based on the above explanation.

From the above, it has been concluded that gravitational force is an electromagnetic force (or electromagnetic wave), which is generated by motion of charge in matter. The resultant force Fg is always positive, as explained hereinbefore. So, gravitational force is always a force of attraction. Also, Fe (electrostatic force vector of gravitation) is the sum of four electrostatic forces, of which two are positive and two are negative. Therefore, the resultant force Fg is significantly weak compared to the electrostatic force F1 (30).

As stated hereinbefore, the probability of finding an electron in spherical coordinates is not uniform, and it varies with distance. Its variations (non-uniformity) are more at shorter distances, which means that motion of electron is more restricted at shorter distances. This reduces the kinetic energy of electrons at shorter distances. As the distance is increased, the kinetic energy of electrons is also increased, because of more uniform probability. The difference in KE of electrons at different distance is the gravitational potential energy.

It has also been concluded that the product of vibrating charge dipole and velocity is gravitation, which is analogous to the theory of magnetism, which says that the product of charge and velocity is magnetism. As explained hereinbefore, rotational motion is equivalent to sinusoidal vibrations in the three axes. Thus, the gravitational field generated will not be omni-directional but will have a specific direction.

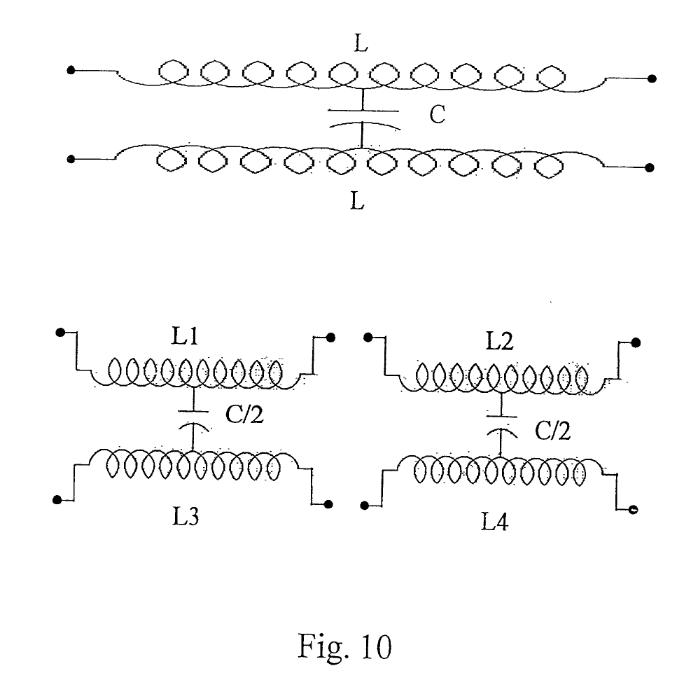

Based on the aforementioned theory, it has been found by the applicant herein that the gravity can be generated with the help of a newly invented electrical component, termed as capacito-inductor (14) which is a four terminal device and generates the combined effect of capacitance and inductance. Such a device with more than 4 terminals will give better results, as illustrated in FIG. 10 of the drawings accompanying this Specification.

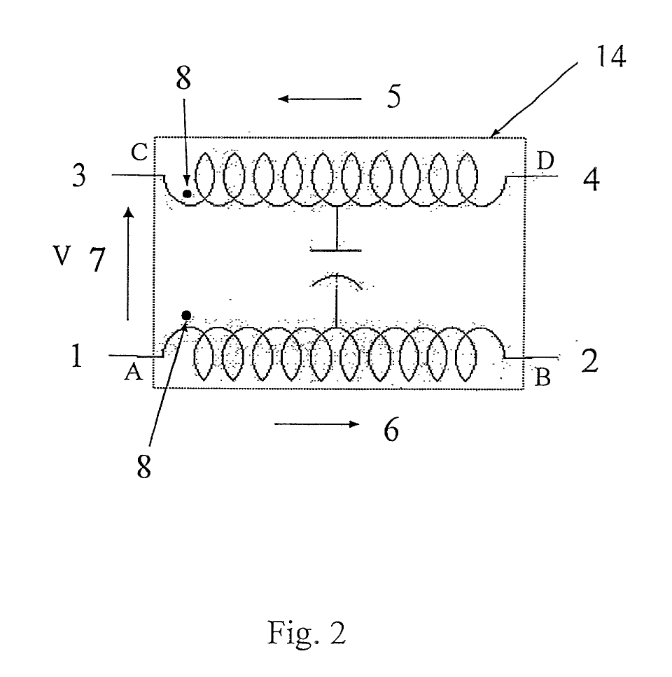

As shown in FIG. 2, the capacito-inductor is constituted by two coils having terminals A(1), B(2) and C(3), D(4), which offer inductance L between A(1) to B(2), and C(3) to D(4). It also has sufficient capacitance between A(1) to C(3) or B(2) to D(4). Its inductance is very small at A(1) to C(3) when B(2) and D(4) are shorted. It is used as the main component for generating gravitational force, by the proposed apparatus, to be described hereinafter with reference to the accompanying drawings. As shown in FIG. 2, equal and opposite current pulses (5 and 6) are applied between the terminals D to C and A to B of the two coils, and voltage (7) is applied between the same end terminals A and C of the two coils. Mutual coupling between the two coils, as explained hereinbefore, is indicated by (8). In the illustrative embodiment of the capacito-inductor, shown in FIG. 10, there are used more than four terminals, by employing coils L1, L2, L3 and L4 and capacitors C/2.

L1 and L2 can be connected either in series or in parallel. Similarly L3 and L4 can also be connected.

More than four terminals in a capacito-inductor will change the impedance of the circuit. This helps in matching the impedance of a current pulse generator.

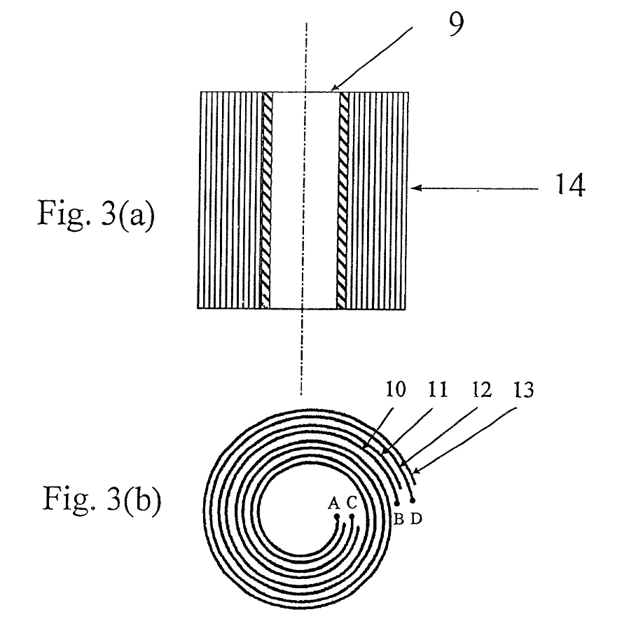

As shown in FIGS. 3(a) and 3(b), the capacito-inductor has:

(a) Core (9);

(b) Metal foil Layer (10);

(c) Dielectric film Layer (11);

(d) Metal foil Layer (12);

(e) Dielectric film Layer (13).

With the help of the said capacito-inductor the generation of gravity can be controlled by the following control parameters:

(i) Applied voltage-V (7);

Function: To orient the charge dipoles inside dielectric;

(ii) Current (6) through metal layer (10) and Current (5) through metal layer (12);

Function: To vibrate the charge dipoles;

(iii) Angular frequency —ω;

Function: To give velocity to the charge dipoles;

(iv) Superimposed vibration amplitude—A;

Function: To compensate the eccentricity of capacito-inductor rotation;

(v) Radial magnetic field Intensity—B;

Function: To tilt the charge dipoles

(vi) Design parameters of capacito-inductor (14):

Dielectric Constant—K,

Number of turns N,

Dielectric Thickness—d,

Internal Diameter—ID,

Outer Diameter—OD.

It is, therefore, clear that the capacito-inductor (14) is a four-layer device with metal foil (10)-dielectric film (11)-metal foil (12)-dielectric film (13), wound on a cylindrical core (9) as shown in FIGS. 3(a) and 3(b). The first layer of the metal film (10) is having its ends as the two terminals of the device i.e. A(1) and B(2), while the second layer of metal film (12) has its ends as other two terminals of the device i.e. C(3) and D(4). These two metal layers have dielectric film layers (11) and (13) in between, as shown in FIG. 3(b).

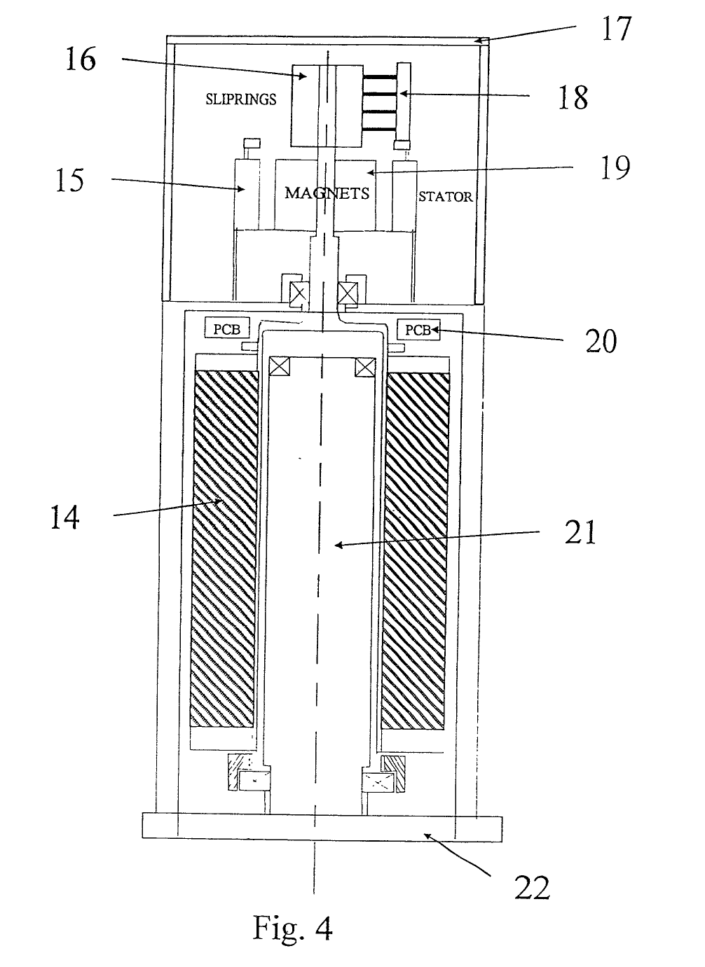

The apparatus according to the present invention, for generating gravitational force/gravitational field, has the following essential constructional features, as shown in FIG. 4:

(i) Capacito-inductor (14);

(ii) Stator of a permanent magnet synchronous motor (PMSM) (15);

(iii) Slip-rings (16) of slip-ring assembly;

(iv) Top cover (17);

(v) Contacts (18) of slip-ring assembly;

(vi) Magnet (19) for synchronous motor;

(vii) PCB (Printed circuit board) (20) for current pulse generator;

(viii) Magnet (21) to create radial magnetic field;

(ix) Bottom cover (22).

In the operation of the apparatus according to the present invention, the magnetic rotor (19) of PMSM (15) rotates all the moving parts including the capacito-inductor (14), PCB (20) and slip-rings (16). The magnet (21) creates a radial magnetic field. Electronic PCB (20) is also mounted on the rotating system and optically couples the two current pulse generators. The slip-ring assembly (16 and 18) is mounted above the PMSM (15) to feed power to electronic PCB. The whole system is covered with the help of the top (17) and bottom (22) covers, as shown in FIG. 4.

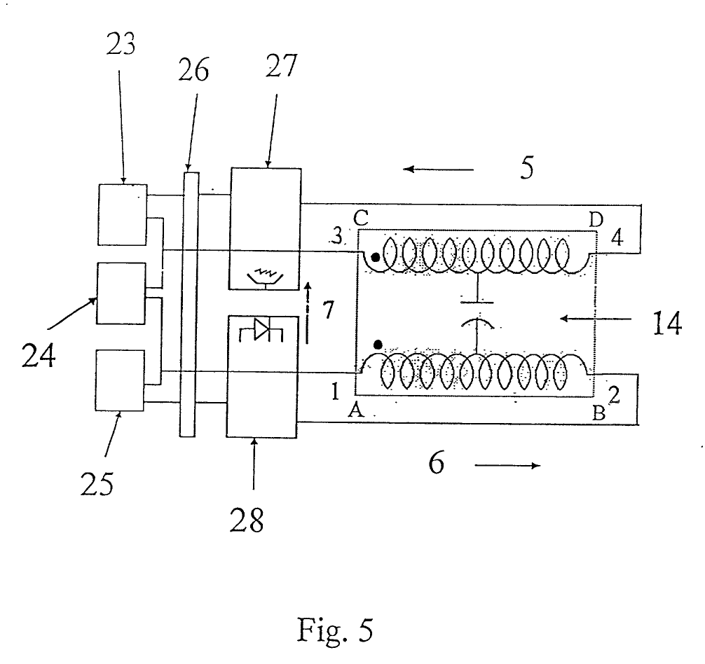

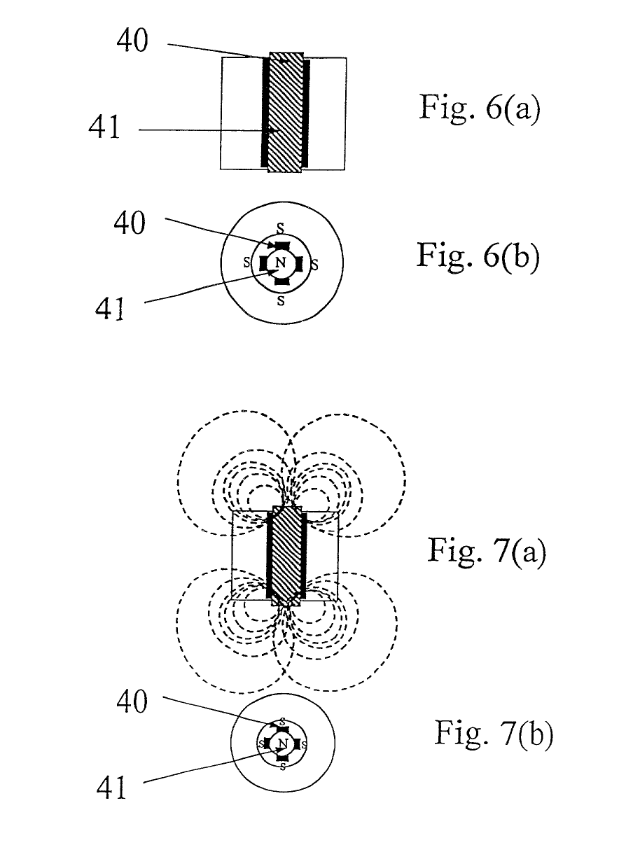

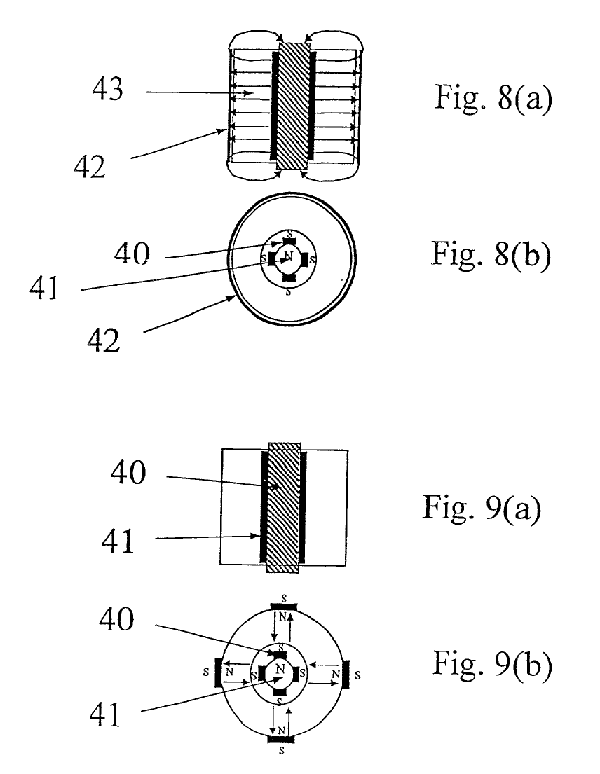

The diverse arrangements for generating magnetic field have been illustrated in FIGS. 6(a), 6(b), 7(a), 7(b), 8(a), 8(b), 9(a) and 9(b) of the drawings accompanying this complete specification. In all the said figures magnets are denoted by (40), iron cores by (41), and iron cylinder by (42). In FIG. 8(a) radial magnetic flux is indicated by (43). The arrangement of FIGS. 8(a) and 8(b) increases the flux and that makes it more radial because path reluctance is reduced. The arrangement of the magnetic circuit shown in FIGS. 9(a) and 9(b) yields comparatively better magnetic flux.

As shown in FIG. 5 of the drawings, the apparatus according to the present invention can be caused to be operated/actuated by means of the following features and in the following manner:

(a) First power supply (23) to feed power to PCB for current pulse generator (27);

(b) Second power supply (24) to apply voltage V (7) on the capacito-inductor (14);

(c) Third power supply (25) to feed power to PCB for current pulse generator (28);

(d) Slip-rings (26) to transfer power to rotating PCB;

(e) Current pulse generator (27) to generate current pulses (5);

(f) Current pulse generator (28) to generate current pulses (6).

The Voltage (7) is applied at the terminal A(1) and C(3) of the coils of the capacito-inductor (14) through the power supply (24). Equal and opposite current pulses are applied at the terminals A(1)-B(2) and C(3)-D(4) of the capacito-inductor (14) with the help of two current pulse generators (28) and (27) respectively. These two current pulse generators are opto-coupled to generate almost equal and opposite current pulses.

The second current pulse generator (27) may be eliminated by short circuiting the terminals C(3) and D(4). In that case, due to high mutual inductance between the two coils A(1)-B(2) and C(3)-D(4) almost equal and opposite current is generated in both the coils with only one current pulse generator (28).

It would therefore, be appreciated that the essential and significant component of the apparatus according to the present invention is a four-layer device with metal (10)-dielectric (11)-metal (12)-dielectric (13) wound on a cylindrical core (9). It is a four terminal device A(1), B(2), C(3), D(4) which offers inductance between A(1) to B(2) and C(3) to D(4). It also has sufficient capacitance between A(1) to C(3) or B(2) to D(4). However, its inductance is very small at A(1) to C(3) when B(2) and D(4) are shorted. It has been termed as capacito-inductor (14). It is placed within a magnetic circuit of permanent magnet (21) which creates radial and tangential magnetic field, as explained. When the capacito-inductor is caused to be rotated at high speed, and voltage (7) is applied between A(1) and C(3), and also opposite current (dipole current) pulses (6) and (5) are applied on the terminal ends A(1)-B(2) and C(3)-D(4) respectively, axial gravitational field is generated. A PMSM (15 and 19), used to rotate the capacito-inductor (14), is controlled with the help of a separate electronic controller. The applied voltage (7) orients charge dipole inside dielectric in radial direction with negative and positive charge towards axis of rotation in alternate layers of dielectric. Rotation of the capacito-inductor (14) in presence of radial and tangential magnetic field tilts all the charge dipole towards negative charge, either down or up, parallel to axis of rotation, depending upon the direction of rotation. As force vector on positive and negative charge is equal and opposite, the resultant effect is torque on charge dipole. The current dipole pulses generate vibration in charge dipole, and rotation of this charge dipole generates gravity.

### EXAMPLES

Test results as achieved from some of the embodiments of the apparatus according to the present invention

### Prototype “A”

ID=62 mm, OD=120 mm, 25 um Polyester, 4.5 um Aluminum, N=453

RAB=6.3E, C=32 uF

Weight of Prototype=10 Kg

Deflection sensitivity of test stand=17 gram/mm

Rotation speed=2800 to 2900 RPM

Current pulses of peak current 6 A approx., Radial magnetic field is applied

DC Voltage between A and C=0 to 700 V

Speed(rpm) 0 2500 2860 3100 3262 3330 2954 2868

Pointer 151 151 152 152 151.5 150.8 151.5 151.5

Voltage(DC) 0 750 0 750

Pointer 151 151.5-152 151 151.5

This shows 0.5 mm deflection in the direction of weight decrease which is equivalent to 0.05% weight reduction.

### Prototype “B”

ID=62 mm, OD=200 mm, 15 um Polyester, 6 um Aluminum, N-1760

R_{AB}=30E, L_{AB}=0.256 H, Capacitance is not measurable correctly by simple

capacitance meter because of high inductance.

Weight of Prototype=18.9 Kg

Deflection sensitivity of test stand=35 gram/mm

Rotation speed=800 to 2000 RPM

Current pulses of peak current 2.5 A approx., Radial magnetic field is applied.

DC Voltage between A and C=0 to 100V Deflection due to weight reduction=0.4 to 0.5 mm. The deflection was reduced to 0.3 mm after trials of one day. However it showed a weight reduction of 0.05%.

It is to be understood that various embodiments of the apparatus according to the present invention are possible within the scope of what has been described hereinbefore, and will be claimed hereinafter.

What is claimed is:

1. An apparatus for generating gravitational force/gravitational field, said apparatus comprising a capacito-inductor, constituted by at least two coils, made of two metal layers with two dielectric layers provided therebetween, said coils being wound in predetermined turns on a cylindrical core of an insulating material; a magnet placed at the centre of said capacito-inductor for creating and passing radial magnetic field through the capacito-inductor; power supplies for applying equal and opposite current pulses at the end terminals of said two metal layers of the capacito-inductor, and also for applying predetermined voltage between the same end terminals of said metal layers; and a drive source for rotating the capacito-inductor, journalled between two covers; the arrangement being such that on high speed rotation of the capacito-inductor in presence of the radial magnetic field, and on application of voltage at the same end terminals of the metal layers, charge dipole is caused to be oriented inside the dielectric layers in radial direction with negative and positive charge towards the axis of rotation of the capacito-inductor in its alternate layers of dielectric, with all the charge dipole being tilted towards negative charge down or up, parallel to the axis of rotation, depending on the direction of rotation; and on application of equal and opposite current pulses between the end terminals of each of said metal layers, vibration is caused to be generated in the charge dipole, which, due to its rotation, generates gravitational force/field.

2. The apparatus as claimed in claim 1, wherein in the capacito-inductor the metal layers used are aluminium foils, the dielectric is polyester, and the cylindrical core is made of a plastic insulating material.

3. The apparatus as claimed in claim 1, wherein the thickness of the metal and dielectric layers is in the range of 0.5 microns and 50 microns.

4. The apparatus as claimed in claim 1, wherein the two coils of capacito-inductor are mutually coupled with the same end terminals in the same direction.

5. The apparatus as claimed in claim 1, wherein more than four terminals are provided in the capacito-inductor by employing a corresponding number of coils and capacitors, said coils being connected either in series or parallel.

6. The apparatus as claimed in claim 1, wherein diverse arrangements are provided for generating magnetic field.

7. A method for generating gravitational force/gravitational field which comprises rotating at high speed a capacito-inductor constituted by at least two coils made of two metal layers with two dielectric layers provided therebetween, said coils being wound in predetermined turns on a cylindrical core of an insulating material with a magnet placed at the centre of said capacito-inductor, for creating and passing a radial magnetic field through the capacito-inductor, and simultaneously applying equal and opposite current pulses at the end terminals of said two metal layers of the capacito-inductor, and applying a predetermined voltage between the same end terminals of said metal layers, whereby the charge dipole is caused to be oriented inside the dielectric layers in radial direction with negative and positive charges towards the axis of rotation of the capicito-inductor in its alternate layers of dielectric, with all the charge dipole being tilted towards negative charge down or up parallel to the axis of rotation, depending on the axis of rotation, and vibration is caused to be generated in the charge dipole on the application of equal and opposite current pulses between the end terminals of each of said metal layers, resulting in generation of gravitational force/field.

8. A surface to air vehicle incorporating an apparatus for generating gravitional force/gravitational field as claimed in claim 1.

9. A surface to air projectile incorporating an apparatus for generating gravitational force/gravitational field as claimed in claim 1.

10. A space vehicle incorporating an apparatus for generating gravitational force/gravitational field as claimed in claim 1.

11. An airborne craft incorporating an apparatus for generating gravitational force/gravitational field as claimed in claim 1.
